(19) United States
(12) Patent Application Publication
(10) Pub. No.: US 2006/0037462 A1
(43) Pub. Date: Feb. 23, 2006

(54) Mine removing system

(75) Inventor: Giovanni Battista Marcolla, Cimone (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Euronord s.a.s. di G.B Marcolla & C.,, Cimone (IT)

(21) Appl. No.: 10/511,073

(22) PCT Filed: Apr. 12, 2002
(86) PCT No.: PCT/IT02/00232

§ 371 Date: Aug. 2, 2005

(51) Int. Cl. B64D 1/04

(52) U.S. Cl. 89/1.13

(57) ABSTRACT

A rapid mine removing system comprises a remote controlled air-means (A) provided with mine—(M), in particular anti-personnel mine-surveying and controlling devices; an also remote controlled terrestrial means (T) provided with mechanical means suited to pick up from the ground the booby traps as located by the air-means (A) for their subsequent blasting through skilled personnel or concurrent hydromechanical neutralization; as well as a terrestrial means (C) with manned crew working at a safety distance according to the data automatically given by the remote controlled means (A, T).

### FIELD OF INVENTION

The present invention relates to a system for reclaiming mined areas and in particular to an integrated, modular and flexible system for locating, controlling and neutralizing antipersonnel mines.

### BACKGROUND

It is known that the presence of areas strewn with mines or generally with booby traps of any kind, and prepared by one or more belligerents for the sake of offending-defending is a serious humanitarian problem, in particular for the civil populations during and after the termination of conflicts, a problem that turns finally out in an economic burden, involving in addition implications of many-sided nature.

On the other hand, the reclaiming of such areas carried out by human personnel, provided when possible with right special equipment, besides being dangerous to the charged people, it is particularly time-consuming and complex.

DE4417262 describes a mine removal system comprising a central unit which controls a mine-locating terrestrial vehicle and a mine-deactivating vehicle. The mine-locating terrestrial vehicle is provided with one or more sensors selected among radar sensors, ultrasound sensors, infrared sensors, X-ray sensors, pressure sensors, optical sensors or magnetic sensors. An airplane using a SAR system and/or a satellite are intended to provide a first, rough location of the mines and are connected to said central unit which, accordingly to the information received, directs the mine-locating terrestrial vehicle.

However, said system is very complicated since its procedure for locating the mines is based on two steps: a first rough location by means of a satellite and a second location step by the terrestrial vehicle. Further, the system is not suitable to recognize a mine with a single kind of sensor, independently on the mine size and on the material of which its shell is formed.

Systems comprising means for deactivating land mines through a high-pressure water ject are also known, for example from the article “Water jet system could deactivate battlefield land mines” NTIS Tech Notes, (1992) US Department of Commerce, Springfield, Va., US, or from the application JP 2000 171198. However, these systems do not comprise means for the location of the mines.

### SUMMARY

The object of the present invention is therefore to propose an integrated system which is safe to the assigned personnel, cheap, quickly feasible and exhaustive with respect to the completeness of the operation.

### BRIEF DESCRIPTION OF THE DRAWING

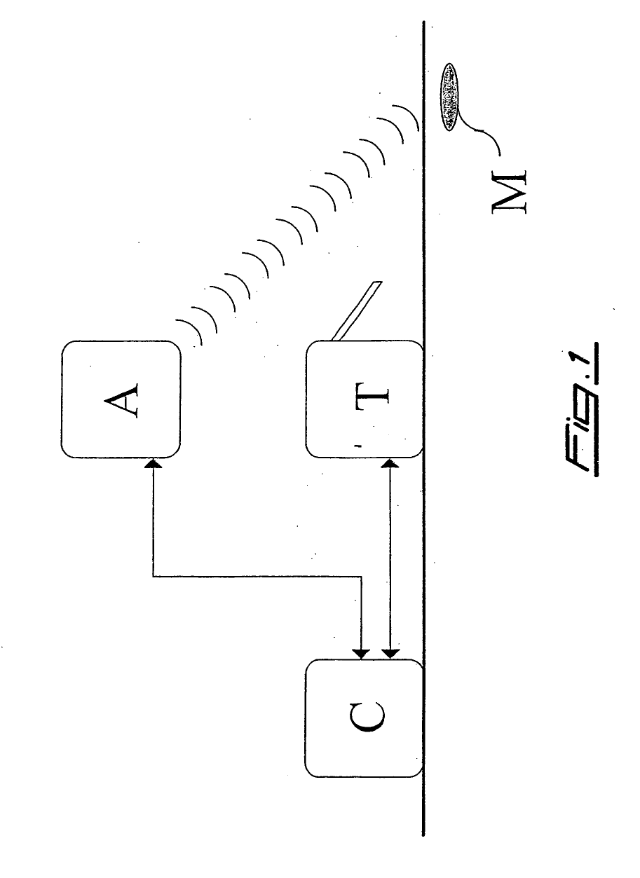

This and other objects and advantages of the system according to the present invention will become more evident from the following specification that refers to a sole drawing, appended as FIG. 1, schematically showing the components of this system.

### DETAILED DESCRIPTION OF THE PREFERRED EMBODIMENT

The proposed system comprises essentially three mutually integrated operating elements, namely: a remote controlled air-means A provided with a maneuverable mechanical arm, a tracked or wheeled terrestrial means T also remote controlled and provided in turn with a mechanical arm, and a further terrestrial means C having manned crew, for the remote survey and a possible corrective intervention on said means in case of need.

The remote controlled air-means A is an aircraft with rotating blades (helicopter or the like, capable of hovering), that by operating at low altitude is able to effect the survey of the underlying ground by means of an electrically or hydraulically operated arm having an action range of about 280° and a nuclearly scanning sensor, able to recognize the nature of the materials forming a buried contrivance M.

The remote controlled terrestrial means T, that is usable in different ground situations (such as sands, dunes, rocks, fords, woodlands, town environments) and able to work in the absence of oxygen too and at temperatures comprised between −70° C. and +290° C., may be tracked or preferably wheeled with four or six independent driving wheels, each of them being equipped with an autonomous electrically or hydropneumatically operated motor. Said means T, thanks to the presence of autonomous motors for the various wheels, is suited to effect weight changes on each individual axle and is able to self-redress in case of lateral tilting as well as to cruise also in case of total tilting. This terrestrial means T is provided, by analogy with air-means A, with a multifunctional arm articulated on four rotary joints and a 360 degree rotating fifth wheel, on which arm there is mounted an electro-hydraulic telescopic gripper with pressure sensor that is able to determine the consistency of possible bodies to be picked-up and to consequently modify the grasping force without squashing.

The remote controlled terrestrial means T is provided in addition with a precision small gun, with a relative laying telecamera, that is intended to “shoot” shells formed of solid, semisolid or liquid masses and capable of both undermining from the ground and neutralize booby traps (antipersonnel mines) M, and of stabilizing unsafe structures by demolishing the endangered parts. The presence of the various named equipment gives to this remote controlled means T a particular versatility, in that it can also be used to extinguish fire centers and fires in progress, to down doors in case of rescues, to pick up inert people in dangerous situations, to salvage wounded persons from dangerous environments owing to the presence of poison gases, as anti-rebellion means, and so on.

In summary, the remote controlled terrestrial means is provided with:

a displacement controlling telecamera; inside propelled wheels; a multi-functional arm; an arm—and propulsion-controlling electronic gearcase; an electrohydraulic compressor; a double independent circuits system; means—guiding and gun-aiming boards; telesurveying and data reception antennas; various protective platings and screenings; various containers and reservoirs.

The terrestrial means C with manned crew is provided with short-range radio instrumentation for the telesurveying and mapping of the territory, also based on the info received from the other system components, and constitutes the control and check component of the system.

One of the peculiar characteristics of the system according to the present invention is the possibility of sensing in the ground also the presence of small sized mines with non-metallic (for example plastics) shell, that are mainly used with an anti-personnel function. This is possible thanks to a nuclear scanning of the materials as allowed by sophisticated computerized programs.

A further important peculiarity of the system at issue is the undermining technique which is applied, besides with mechanical drilling and grasping means, also with ballistic, hydraulic or hydromechanical means, wherein the undermining and neutralizing action is carried out by a violent (explosive) ejection of fluid (e.g. aqueous) means directed through the ground on the object to be removed. The apparatus intended for this purpose uses a fire-producing propellant (such as ballistite) that imparts the required penetration force to a liquid (aqueous) mixture which is ejected through a suitably sized nozzle. As an alternative to the fire-producing propellant, a high pressure mixed propellant can be used in connection with a powerful compressor.

Although a particular structure of the mine removal system according to the present invention has been described, it is clear that possible changes may be introduced in it without distorting its spirit and substance. It will thus be possible to substitute for the air-means A with rotating blades a suitably equipped air-balloon, which is particularly useful, not to say necessary, in woodland and/or rocky areas, and the like, where the use of an helicopter would be dangerous or impracticable.

A further change to the operating system of the present invention would concern not only the operational modes, but also the applicative aims. It would thus be possible to use the fundamental equipment in fields such as the archaeological, botanical, architectural research, in medicine, and so on.

In summary, the peculiar features of the proposed system are:
absolute safety for the operators;
low practice costs with respect to the presently used systems;
extremely high operating rapidity;
advanced and specific driving and controlling software programs.

1. A mine removal system in mined areas, comprising three independent and co-ordinated modular units (C, A, T) respectively formed of a remote controlled air-means (A) acting above the ground; a remote controlled self-propelled terrestrial means (T), and autonomous terrestrial means (C) with manned crew forming the control and check unit of the system, characterized in that said air-means is an aircraft provided with a maneuverable mechanical arm and a nuclearly scanning sensor capable of effecting survey of the underlying ground.

2. A mine removal system according to claim 1, characterized in that said terrestrial means (T) is provided with a gun able to shoot shells formed of solid, semisolid or liquid masses.

3. A mine removal system according to claim 2, characterized in that said gun uses a fire-producing propellant.

4. A mine removal system according to claim 3, characterized in that said fire-producing propellant is ballistite.

5. A mine removal system according to claim 4, characterized in that said gun uses a high pressure mixed propellant in connection with a powerful compressor.

6. A mine removal system according to claim 1, characterized in that said maneuverable mechanical arm is electrically or hydraulically operated and has an action range of about 280°.

7. A mine removal system according to claim 1, characterized in that said terrestrial means (T) is provided with a multifunctional articulated arm on which there are mounted mechanical drilling and grasping means with pressure sensor able to determine the consistency of possible bodies to be picked up and to consequently modify the grasping force without squashing.

8. A mine removal system according to claim 7, characterized in that said multifunctional arm is articulated on four rotary joints and a 360° rotating fifth wheel.

9. A mine removal system according to claim 1, characterized in that said terrestrial means (T) is wheeled with four or six independent driving wheels, each being equipped with an autonomous electrically or hydropneumatically operated motor.

10. A mine removal system according to claim 7, characterized in that said grasping means are formed of an electro-hydraulic telescopic gripper.
